(19) United States
(12) Patent Application Publication
(10) Pub. No.: US 2007/0161765 A1
(43) Pub. Date: Jul. 12, 2007

(54) Thermally polymerisable mixtures of multifunctional macromonomers, polymerisation initiators

(75) Inventors: Kathrin Michl, Ludwigshafen (DE); Matthias Gerst, Neustadt (DE); Yvonne Heischkel, Mannheim (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschfaft, Ludwigshafen (DE)

(21) Appl. No.: 10/586,134

(22) PCT Filed: Jan. 14, 2005
(86) PCT No.: PCT/EP05/00311

§ 371 Date: Jul. 17, 2006

(30) Foreign Application Priority Data
Jan. 21, 2004 (DE) 102004003262.9

(51) Int. Cl. C08F 4/00; C08F 2/00

(52) U.S. Cl. 526/217; 526/319; 526/227; 526/313

(57) ABSTRACT

Thermally polymerizable mixtures of multifunctional macromonomers comprising at least one free-radically polymerizable group and polymerization initiators and use of these mixtures as binders for substrates, especially as binders for glass fibers, rock wool, natural fibers, manufactured fibers and for core sand binding.

### DESCRIPTION

This invention relates to thermally polymerizable mixtures of multifunctional macromonomers and polymerization initiators and their use as binders for substrates.

U.S. Pat. No. 5,275,874 discloses production of glass fiber insulation comprising glass fibers bonded together with a UV-cured binder based on methacrylate or maleate. To achieve uniform curing of the binder, the binder-treated glass fibers have to be exposed to UV radiation for a prolonged period. As a result, however, the binder at the surface of the glass fiber/binder mixture to be irradiated is damaged.

U.S. Pat. No. 6,221,973 discloses a formaldehyde-free curable aqueous composition containing a polyacid, a polyol and a phosphorus-containing accelerator for use as a binder for heat-resistant nonwovens, for example glass fibers.

EP-A-0 990 727 discloses a mineral fiber binder consisting of a low molecular weight polycarboxy polymer and a polyol and having a pH not greater than 3.5.

U.S. Pat. No. 5,932,665 discloses binders based on polycarboxy polymer which, through adjustment of the molecular weight and the copolymer composition, are curable at lower temperatures than comparable systems based on homopolyacrylic acids.

WO-A-97/31036 describes formaldehyde-free aqueous binders formed from an ethylenically unsaturated acid anhydride or an ethylenically unsaturated dicarboxylic acid and an alkanolamine which are useful as coatings, impregnants and binders for fiber webs.

DE-A-44 10 020 discloses a process for addition polymerization of substances in fiber materials, as in particular of binders in mineral fiber material for insulation purposes, wherein the binder-treated fiber material is irradiated with electron beams. Examples of binders which can be used are compounds which comprise two or more ethylenically unsaturated double bonds in the molecule, for example 1,6-hexanediol diacrylate, tripropylene glycol triacrylate, ethoxylated trimethylolpropane triacrylate or ethoxylated pentaerythritol tetraacrylate.

DE-A-44 21 254 discloses a process for addition polymerization of prepolymers in fiber materials for producing mineral wool materials for insulation purposes wherein the fiber material is impregnated with prepolymers and the fiber material thus coated is briefly exposed in a certain thickness to high-intensity UV radiation such that complete addition polymerization of the prepolymers takes place and degradation of organic entities on the surface of the coated fiber material is avoided. Useful prepolymers include multifunctional acryloyl or methacryloyl compounds, for example oligomers or polymers having polymerizable, unsaturated functional groups such as acrylate, methacrylate, vinyl, vinyl ether, allyl or maleate groups which react to provide chain extension and/or crosslinking. The binder can be a mixture of such oligomers and comprise a photoinitiator.

In processes wherein the addition polymerization of binders such as monomers or prepolymers is effected in a fiber matrix with the aid of radiative curing, the binder-coated fiber material can only be cured to the extent that the radiation will penetrate the material. Since radiation intensity decreases quickly with increasing layer thickness, however, nonuniform polymerization of the monomers or prepolymers is likely unless certain costly and inconvenient measures are taken.

WO-A-91/10713 discloses an aqueous coating composition used in particular for coating finish foils and continuous edging. It consists of two components I and II. Component I comprises at least one water-thinnable melamine and/or urea resin, at least one hydroxyl-containing polyester and if appropriate pigments, customary auxiliary and additive entities, and also diluent and component II comprises an acidic curing catalyst. The melamine and/or urea resins comprised in the composition comprise co-condensed formaldehyde which may become detached to a small degree when the coating is subjected to a thermal stress for example.

EP-A-0 279 303 discloses radiation-curable acrylates obtainable by reaction of (A) one equivalent of a 2- to 6-hydric alkoxylated C₂ to C₁₀ alcohol with (B) 0.05 to 1 equivalent of a 2- to 4-basic C₃ to C₃₆ carboxylic acid or anhydride and (C) 0.1 to 1.5 equivalents of acrylic acid and/or methacrylic acid and subsequent reaction of excess carboxyl groups with the equivalent amount of an epoxy compound. The acrylates thus prepared are if appropriate admixed with reactive diluents such as 4-tert-butylcyclohexyl acrylate or hexanediol diacrylate and used as coatings and overcoatings. To this end, they may be dispersed in water by means of a dispersant and applied in the form of aqueous dispersions for example to fiber webs and cured by the action of electron beams or, after addition of photoinitiators, by irradiation with UV light cf. also DE-A-28 53 921.

Radiation-curable reaction products of acrylates and epoxy compounds such as epoxidized olefins or glycidyl esters of saturated or unsaturated carboxylic acids are known from EP-A-0 686 632. Radiation-curable urethane acrylates are also known, cf. prior, as yet unpublished DE application 102 59 673.

The present invention has for its object to provide formaldehyde-free binders for fibrous and/or granular substrates such as glass fiber, rock wool, other manufactured and natural fibers and sand for production of shaped articles such as in particular mats or panels. The binders shall endow the shaped articles with high mechanical strength and dimensional stability.

This object is achieved according to the invention by thermally polymerizable mixtures consisting of multifunctional macromonomers comprising at least one free-radically polymerizable group and polymerization initiators. The macromonomers contain for example acrylate, methacrylate, maleate, vinyl ether, vinyl and/or allyl groups as free-radically polymerizable groups.

Useful multifunctional macromonomers include prepolymers known for example from the above-cited references EP-A-0 279 303, EP-A-0 686 621, DE-A-44 21 254 and prior DE application 102 59 673. The multifunctional macromonomers comprise at least one free-radically polymerizable group selected for example from acrylate, methacrylate, maleate, vinyl ether, vinyl and allyl groups. The double bond content of the macromonomers is for example in the range from 0.1 to 1.0 mol/100 g and preferably in the range from 0.2 to 0.8 mol/100 g of macromonomer (100% pure). Accordingly, the macromonomers have for example a functionality in the range from 1.5 to 7.0 and especially from 1.6 to 5.0 per molecule. When the macromonomers comprise more than one functional group, these groups may be the same or different The molar masses M_{w} of the macromonomers is for example in the range from 300 to 30 000 and preferably in the range from 500 to 20 000 g/mol.

Multifunctional macromonomers are obtainable for example by condensation of at least difunctional polyols which may comprise 2-30 mol of ethylene oxide and/or propylene oxide with polycarboxylic acids and/or carboxylic anhydrides and/or difunctional alcohols (C₂-C₁₈) and/or alkanolamines comprising at least two OH groups in the molecule with ethylenically unsaturated carboxylic acids.

Examples of ethylenically unsaturated C₃ to C₅ carboxylic acids are for example acrylic acid, methacrylic acid, crotonic acid, maleic acid, ethylacrylic acid and vinylacetic acid, preferably acrylic acid and methacrylic acid. Preferred polycarboxylic acids are unsaturated C₄ to C₃₆ dicarboxylic acids, for example succinic acid, glutaric acid, sebacic acid, adipic acid, o-phthalic acid, their isomers and hydrogenation products and also esterifiable derivatives, or dialkyl esters of the aforementioned acids or trimellitic acid. Preferred carboxylic anhydrides are maleic anhydride, phthalic anhydride, succinic anhydride and itaconic anhydride. Excess acid in the reaction product is removed, either by neutralization and washing out with water or by reaction with epoxides under catalysis (tertiary amines, ammonium salts) to form epoxy acrylates, which remain in the reaction mixture.

The reaction products can then be reacted with a polyisocyanate, for example 2,4-toluene diisocyanate, in the presence or absence of a chain extender such as hydroxyethyl acrylate to form macromonomers containing acrylate and polyurethane groups.

Preferred diols are ethylene glycol, 1,2-propylene glycol, 1,3-propylene glycol, 1,4-butanediol, 1,6-hexanediol, neopentylglycol, cyclohexanedimethanol and also polyglycols which comprise ethylene oxide and/or propylene oxide units. Examples of polyols are trimethylolpropane, glycerol or pentaerythritol. The diols and polyols may if appropriate have been reacted with ethylene oxide or propylene oxide to form polyethers. Up to 30 mol of ethylene oxide and/or propylene oxide, usually 2 to 30 and preferably 2 to 10 mol of ethylene oxide or propylene oxide is used per OH group of diols or polyols. OH-containing polyesters also include polycaprolactone diols and triols.

The esterification of hydroxyl-containing polyesters with acrylic acid and/or methacrylic acid may also be carried out by introducing these acids as part of the initial charge together with the starting materials for preparing the OH-containing polyesters for example dicarboxylic acids or anhydrides and diols/polyols and condensing these starting materials together with acrylic acid and or methacrylic acid in one step.

The amount of acrylic acid and/or methacrylic acid used to esterify the OH-containing compounds is preferably in the range from 0.1 to 1.5, especially in the range from 0.5 to 1.4 and most preferably in the range from 0.7 to 1.3 equivalents of acrylic acid and/or methacrylic acid per hydroxyl group equivalent of the hydroxy compound.

The reaction of acrylic acid and/or methacrylic acid with the hydroxyl-containing compounds is carried out for example in the presence of an acidic esterification catalyst such as sulfuric acid or p-toluenesulfonic acid. The esterification can also be carried out in the presence of a hydrocarbon which forms an azeotropic mixture with water. The water formed in the course of the esterification is then advantageously removed from the reaction mixture by azeotropic distillation. After the esterification has been concluded, the solvent can be distilled out of the reaction mixture, the distillation being preferably carried out under reduced pressure in order that thermal damage to the reaction product may be avoided.

Preferred multifunctional macromonomers are obtainable for example by co-reacting

a) 0.5-2.0 equivalents of a 2- to 6-hydric alkoxylated alcohol with

b) 0 to 1 equivalent of a 2- to 4-basic C₃ to C₁₆ carboxylic acid and/or anhydride and

c) 0.1 to 1.5 equivalents of acrylic acid and/or methacrylic acid

d) 0 to 1 equivalent of diol

and then reacting the thus obtained reaction product with an epoxy compound.

Useful epoxy compounds have at least one, preferably at least two or three epoxy groups in the molecule, for example epoxidized olefins, glycidyl esters of saturated or unsaturated carboxylic acids or glycidyl ethers of aliphatic or aromatic polyols. Such products are commercially available, for example polyglycidyl compounds of the bisphenol A type and glycidyl ethers of polyfunctional alcohols such as butanediol, glycerol or pentaerythritol, such as Epikote® 812 (epoxy value: about 0.67), Epikote 828 (epoxy value: about 0.53) and Epikote 162 (epoxy value: about 0.61).

The epoxy compounds are added to the first stage reaction product in amounts which are generally in the range from 1% to 20% by weight and preferably in the range from 5% to 15% by weight, based on the reaction product of the first stage. Particular preference is given to using equimolar amounts of epoxy compounds, based on the acid equivalents still present in the reaction product of the first stage. The reaction with epoxy compounds in the second stage of the reaction serves to bind excess starting or unconverted acid, especially acrylic acid and/or methacrylic acid, but also for example dicarboxylic acid present in the starting mixture or resultant monoesters of dicarboxylic acids having a free acid group as epoxy esters. The reaction with epoxy compounds is preferably at 90 to 130, preferably at 100 to 110° C. The reaction is continued until the reaction mixture has an acid number below 10 and especially below 5 mg of KOH/g. The reaction of the epoxy compounds with the acid groups of the first stage reaction products is in the prior art preferably carried out in the presence of quaternary ammonium or phosphonium compounds, cf. EP-A-0 686 621. They are used in amounts of for example 0.01% to 5% and especially 0.1% to 2% by weight, based on epoxy compounds.

Further multifunctional macromonomers are preparable for example by reacting the above-described multifunctional macromonomers after the reaction with an epoxy compound additionally with a polyisocyanate for example 2,4-toluene diisocyanate in the presence or absence of a chain extender such as hydroxyethyl acrylate to form macromonomers comprising acrylate and polyurethane groups.

The macromonomers comprising multifunctional groups are mostly prepared in the presence of inhibitors adapted to prevent premature polymerization of the monomers. According to the invention, they are mixed with thermal polymerization initiators which initiate the polymerization of ethylenically unsaturated compounds by decomposing into free radicals on heating for example to temperatures above 40° C. and preferably above 50° C. The present invention's mixtures of multifunctional macromonomers and polymerization initiators comprise (all percentages being based on solids) 0.05% to 15% and preferably 0.5% to 10% by weight of at least one thermal polymerization initiator and 99.95% to 85% and preferably 99.5% to 90% by weight of multifunctional macromonomers. Particular preference is given to such mixtures which comprise 1.0% to 5.0% of at least one polymerization initiator which initiates the polymerization of the macromonomers by decomposing into free radicals when the mixtures are heated.

Useful polymerization initiators include for example peroxides, hydroperoxides, peroxydisulfates, percarbonates, peroxyesters, hydrogen peroxide and azo compounds. Examples of initiators, soluble or else insoluble in water, are hydrogen peroxide, dibenzoyl peroxide, dicyclohexyl peroxydicarbonate, dilauroyl peroxide, methyl ethyl ketone peroxide, di-tert-butyl peroxide, acetylacetone peroxide, tert-butyl hydroperoxide, cumene hydroperoxide, tert-butyl perneodecanoate, tert-amyl perpivalate, tert-butyl perpivalate, tert-butyl perneohexanoate, tert-butyl per-2-ethylhexanoate, tert-butyl perbenzoate, lithium peroxydisulfate, sodium peroxydisulfate, potassium peroxydisulfate, ammonium peroxydisulfate, azodiisobutyronitrile, 2,2′-azobis(2-amidinopropane) dihydrochloride, 2-(carbamoylazo)isobutyronitrile and 4,4-azobis(4-cyanovaleric acid).

The initiators can be used alone or in a mixture with each other, for example mixtures of hydrogen peroxide and sodium peroxydisulfate. A polymerization in an aqueous medium is preferably carried out using water-soluble initiators.

Similarly, the known redox initiator systems can be used as polymerization initiators. Such redox initiator systems contain at least one peroxide-containing compound combined with a redox co-initiator, for example reducing sulfur compounds, for example bisulfites, sulfites, thiosulfates, dithionites and tetrathionates of alkali metals and ammonium compounds. For instance, combinations of peroxodisulfates with alkali metal or ammonium bisulfites can be used, for example ammonium peroxydisulfate and ammonium disulfite. The ratio of peroxide-containing compound to redox co-initiator is for example in the range from 30:1 to 0.05:1.

The initiators or redox initiator systems can be used in combination with transition metal catalysts, for example salts of iron, cobalt, nickel, copper, vanadium and manganese. Examples of suitable salt are iron(II) sulfate, cobalt(II) chloride, nickel(II) sulfate, copper(I) chloride. Based on monomers, the reducing transition metal salt is used in a concentration from 0.1 ppm to 1 000 ppm. For instance, combinations of hydrogen peroxide with iron(II) salts can be used, such as for example 0.5% to 30% of hydrogen peroxide and 0.1 to 500 ppm of Mohr's salt.

Similarly, a polymerization in organic solvents can be carried out using the abovementioned initiators in combination with redox co-initiators and/or transition metal catalysts, for example benzoin, dimethylaniline, ascorbic acid and also solvent-soluble complexes of heavy metals, such as copper, cobalt, iron, manganese, nickel and chromium. The amounts of redox co-initiators or transition metal catalysts customarily used here customarily range from about 0.1 to 1 000 ppm, based on the amounts of monomers used.

The formaldehyde-free mixtures of multifunctional macromonomers and thermal polymerizatiori initiators may if appripriate further comprise at least one customary additive in the customary amounts, for example emulsifiers, pigments, fillers, curing agents, antimigration agents, plasticizers, biocides, dyes, antioxidants and waxes. The amounts of customary additives are in the range from 0.5% to 20% by weight for example.

The present invention further provides for the use of thermally polymerizable mixtures of multifunctional macromonomers comprising at least one free-radically polymerizable group and polymerization initiators, as binders for substrates. Examples of fibrous substrates are glass fibers, rock wool, natural fibers such as cotton, fibers composed of wood and sisal, manufactured fibers such as fibers composed of polyester, polyacrylonitrile and nylon. The thermally polymerizable mixtures are also useful for binding granular substrates, such as core sand for example. This provides, depending on the shaping process, variously shaped articles, for example batts, mats, slabs or differently shaped articles. The substrates are for example impregnated with the thermally polymerizable mixtures by spraying with solutions or dispersions of the mixtures or dipping the substrate into a solution or dispersion of the mixture and allowing excess binder solution or dispersion of the binder to drip off. The coated or impregnated substrates are consolidated by heating to a temperature at which the mixtures of the present invention polymerize. This temperature is dependent on the particular decomposition characteristics of the polymerization initiator which is present in the mixtures. The substrates coated or impregnated with the mixtures of the present invention are mostly heated to temperatures in the range from 160 to 250° C. and preferably from 180 to 220° C. The heating time depends on various factors such as the thickness of the layer, the identity of the macromonomers and the decomposition temperature of the polymerization initiator. The heating time is for example in the range from 2 to 90 minutes and is preferably in the range from 2 to 30 minutes.

When the mixtures of the present invention are used as binders, they are used for example at from 2% to 35% and preferably at from 5% to 25% by weight, based on the weight of the substrates. The moldings obtained have high mechanical strength and dimensional stability not only in a moist climate but also at elevated temperature.

Bonded batts are used for example in the building construction sector as an insulating material in the form of continuous sheets or panels. The binders of the present invention are also useful for manufacturing saucepan cleaners and scourers based on bonded fiber webs.

The percentages in the examples are by weight, unless the context suggests otherwise.

### EXAMPLE 1

390 g of water and 180 g of a polymeric dispersing assistant (30% aqueous solution of a copolymer comprising N-vinylpyrrolidone, vinyl acetate and vinyl versatate units, having an efflux time of about 80 s, measured with Ford cup 5 according to German Standard Specification DIN 53211) were placed as an initial charge in a stirred vessel and mixed by stirring with 450 g of a polyester acrylate prepared as described in Example 1 of EP-A-0 279 303 (polyester acrylate prepared by condensation of ethoxylated trimethylolpropane having an OH number of 630 mg of KOH/g, maleic anhydride and acrylic acid and subsequent reaction with the diglycidyl ether of bisphenol A).

This gave 1000 g of an aqueous dispersion having a viscosity of 250 mPas. The dispersion was admixed with 2% (based on solids) of t-butyl perbenzoate.

### EXAMPLE 2

1170 g of 3:1 (molar ratio) propoxylated/ethoxylated trimethylolpropane having an OH number of 480 mg of KOH/g, 900 g of acrylic acid and 9 g of concentrated sulfuric acid, 560 g of cyclohexane were heated up in a stirrer- and Dean & Stark-equipped apparatus in the presence of 1.9 g of t-butyl-p-cresol, 1.9 g of triphenyl phosphite, 1.9 g of hypophosphorous acid (50% in water), 5.6 g of 4-methoxyphenol and 0.2 g of phenothiazine. 200 g of water were collected in the course of 8 hours. The solvent was then distilled off under reduced pressure (20 mbar) at 100° C. After distillation, the acid number of the resin was about 1 mg of KOH/g. It had a DIN 53019 viscosity of 90 mPas. The polyether acrylate resin thus obtained was subsequently admixed with 2% of t-butyl perbenzoate.

### EXAMPLE 3

470 g of ethoxylated pentaerythritol having an OH number of 620 mg of KOH/g, 440 g of acrylic acid and 2.5 g of concentrated sulfuric acid, 300 g of methylcyclohexane were heated up in a stirrer- and Dean & Stark-equipped apparatus in the presence of 1 g of t-butyl-p-cresol, 1 g of triphenyl phosphite, 1 g of hypophosphorous acid (50% in water), 3 g of 4-methoxyphenol and 0.1 g of phenothiazine. 84 g of water had been collected after a reaction time of 8 hours, when 14 g of a 75% aqueous tetra(n-butyl)ammonium bromide solution were added. The solvent was subsequently distilled off under reduced pressure (20 mbar) at 112° C. The acid number after distillation was about 80 mg of KOH/g. Excess acrylic acid was reacted with 200 g of bisphenol A diglycidyl ether, epoxy content of about 5.4 mol/kg, at 105-110° C. for 6 hours. The acid number of the polyether acrylate obtained was <5 mg of KOH/g. The DIN 53019 viscosity of the resin was 1.0 Pas. The resin was admixed with 2% of t-butyl perbenzoate.

### EXAMPLE 4

1039.0 g of an approximately 15-tuply ethoxylated trimethylolpropane were esterified in a stirrer- and Dean & Stark-equipped apparatus with 304.0 g of acrylic acid and 6.1 g of sulfuric acid (96%) in 450.0 g of methylcyclohexane at an internal temperature of 98 to 105° C. Stabilization was effected with 1.2 g of t-butyl-p-cresol, 1.2 g of triphenyl phosphite, 1.2 g of hypophosphorous acid (50% in water), 4.0 g of 4-methoxyphenol and 0.037 g of phenothiazine. After a reaction time of 10 hours, 40.7 g of a 75% aqueous tetra(n-butyl)ammonium bromide solution were added and the solvent was distilled off under reduced pressure (20 mbar) at 112° C. The acid number after distillation was 25 mg of KOH/g. The OH number was 40 mg of KOH/g. Excess acrylic acid was reacted with 106 g of bisphenol A diglycidyl ether, epoxy content about 5.4 mol/kg, at 105-1 10° C. for 2 hours. The acid number of the acrylate obtained was 2.0 mg of KOH/g, the OH number was 50 mg of KOH/g.

A stirrer-equipped apparatus was charged with 467.5 g of the above-described acrylate, 30 g of hydroxyethyl acrylate and 0.1 g of dibutyltin dilaurate. The initial charge was heated to 56° C., then 58.2 g of 2,4-toluene diisocyanate were added dropwise at an internal temperature of 55 to 65° C. in the course of 20 min. The reaction was continued for 7 hours at an internal temperature of 65-70° C. until the isocyanate content had dropped to 0.5% by weight. At this point 1.5 g of methanol were added and the reaction was continued at the same temperature for about 3 hours until the isocyanate content had dropped to below 0.2% by weight. The urethane acrylate thus prepared was subsequently admixed with 2% of t-butyl perbenzoate.

Performance Testing:

Binder Formulation:

in each case 1% (based on solids) of Silquest A-1 100 γ-aminopropyltriethoxysilane.

Base Web:

glass web, about 50 g/m²

Consolidation of glass web with mixtures, of multifunctional macromonomers and peroxides, prepared as described in Examples 1 to 4.

(a) With Aqueous Binders

Glass webs 32 cm in length and 28 cm in width were led in the longitudinal direction, via an endless PES screen belt, first through a 20% aqueous binder liquor, which each comprised a mixture (of multifunctional macromonomer and peroxide) prepared as described in Examples 1 to 4, and subsequently over a suction apparatus. The belt speed was 0.6 m/min. Wet add-on was controlled by adjusting the intensity of suction. A wet add-on of about 100% from a 20% liquor concentration of the mixture of multifunctional macromonomer and peroxide gave a dry add-on of 20%±2%.

b) Acetone-Dissolved Binders

The glass web was in each case placed into a 5% solution of the binder (a mixture prepared as described in Example 1 to 4, of multifunctional macromonomer and peroxide) in acetone. After the solution had dripped off, the impregnated material was predried at 60° C. for 5 min. The binder quantity was adjusted to 20%+2%, as for the aqueous impregnation.

The impregnated webs were cured at 200° C. for 3 minutes on a PES net support in a Mathis dryer (hot air set to maximum).

Preparation of Test Specimens:

From each impregnated web, 5 test specimens for testing the breaking strength and 6 for testing the flexural rigidity in the longitudinal direction were cut. The size of the webs was as follows:
for breaking strength at 23° C. without further treatment (“dry”) 240×50 mm
for breaking strength after 15 min storage in hot water at 80° C. (“wet”) 240×50 mm
for breaking strength at 1 80° C. (“hot”) 200×50 mm
for flexural rigidity 70×30 mm.
   Tests:
   (a) Breaking Strengths

The averaged test results are reported in N/5 cm; the clamped length was 200 mm for “dry” and “wet” breaking strength and 140 mm for “hot” breaking strength. The extension speed was set to 25 mm/min. For the “hot” measurement, the sample was heated to 180° C. for one minute in a sample chamber. The breaking strength was determined after a further minute at 180° C. The breaking strengths were weight corrected to 60 g/m² (calculation formula: Fₘₐₓ*60 μg/ml/“actual weight” [g/m²]). They are reported in the tables.

b) Flexural Rigidity

The test strip was in each case fixed in a clamp and bent at an angle of 20° at a distance of 10 mm by way of a holder. The height of the test strip was 30 mm. The force measured represents the flexural rigidity. A total of 6 test specimens were measured, each from the facing side and the reverse side, and the measurements averaged. The results obtained are reported in the tables.

| Base web | Breaking | Breaking | Breaking | |
|---|---|---|---|---|
| impregnated with | strength “dry” | strength “wet” | strength “hot” | Flexural rigidity |
| mixture as per | [N/5 cm] | [N/5 cm] | [N/5 cm] | [mN] |
| No impregnation | 64 | 15 | 44 | 65 |
| (comparison 1) | | | | |
| Example 1 | 88 | 40 | 44 | 65 |
| Example 2 | 118 | 44 | 47 | 74 |
| Example 3 | 129 | 66 | 71 | 174 |
| Example 4 | 96 | 46 | 61 | 69 |

Curing not as described above: 30 min at 200° C. in drying cabinet under nitrogen atmosphere

| Base web | Breaking | Breaking | Breaking | |
|---|---|---|---|---|
| impregnated with | strength “dry” | strength “wet” | strength “hot” | Flexural rigidity |
| mixture as per | [N/5 cm] | [N/5 cm] | [N/5 cm] | [mN] |
| Example 1 | 199 | 114 | 84 | 185 |
| Example 2 | 144 | 96 | 76 | 130 |
| Example 3 | 165 | 105 | 78 | 125 |
| Example 4 | 106 | 63 | 75 | 95 |

1-9. (canceled)

10. The method of using a thermally polymerizable mixture consisting of a multifunctional macromonomer comprising one or more free-radically polymerizable double bonds and a polymerization initiator as a binder for a fibrous or granular substrate.

11. The method of using according to claim 10 wherein said thermally polymerizable mixture is used as a binder for glass fiber, rock wool, natural fiber, manufactured fiber and for core sand binding.

12. The method of using according to claim 10 wherein said macro-monomers comprise acrylate, methacrylate, maleate, vinyl ether, vinyl and/or allyl groups as free-radically polymerizable groups.

13. The method of using according to claim 10 where for the molar mass M_{W} of said multifunctional macromonomer is in the range from 300 to 30,000.

14. The method of using according to claim 13 where for the molar mass M_{W} of said multifunctional macromonomer is in the range from 500 to 20,000.

15. The method of using according to claim 10 where for said multifunctional macromonomer is obtainable by co-reacting.
a) 0.5-2.0 equivalents of a 2- to 6-hydric alkoxylated alcohol with
b) 0 to 1 equivalent of a 2- to 4-basic C₃ to C₁₆ carboxylic acid and/or anhydride and
c) 0.1 to 1.5 equivalents of acrylic acid and/or methacrylic acid
d) 0 to 1 equivalent of diol
and then reacting the thus obtainable reaction product with at least one epoxy compound.

16. The method of using according to claim 15 wherefor said multifunctional macromonomer is obtainable by subsequently reacting the product of the reaction of an epoxy compound with said reaction product with a polyisocyanate in the presence or absence of a chain extender to form a macromonomer comprising acrylate and polyurethane groups.

17. The method of using according to claim 10 wherein said polymerization initiator is at least one selected from the group consisting of peroxides, hydroperoxides, peroxydisulfates, percarbonates, peroxyesters, hydrogen peroxide and azo compounds.

18. The method of using according to claim 10 comprising 0.05% to 15% by weight solids of a polymerization initiator.
